(19) United States
(12) Patent Application Publication
(10) Pub. No.: US 2021/0198936 A1
(43) Pub. Date: Jul. 1, 2021

(54) A COMPACT CABINET

(71) Applicant: Ufuk MAHMUTYAZICIOGLU, Lugano (CH)

(72) Inventor: Ufuk MAHMUTYAZICIOGLU, Lugano (CH)

(21) Appl. No.: 17/057,732

(22) PCT Filed: May 29, 2019
(86) PCT No.: PCT/TR2019/050389

§ 371 Date: Nov. 23, 2020

(30) Foreign Application Priority Data
Jun. 8, 2018 (TR) 2018/08161

(51) Int. Cl. E05G 1/024; A47F 3/00; E05G 1/10; A47B 53/02

(52) U.S. Cl. CPC E05G 1/024; A47F 3/001; E05G 1/06; A47B 53/02; E05G 1/10

(57) ABSTRACT

The present invention relates to an innovative system and method of design in compact archive cabinets used to store valuable inventory, pieces of art, and other materials, items and documents that need preservation in museum, library or office-like environments, that provides passive humidity and fire control inside, which employs special dual-purpose insulating frames (3), perforated metallic sheets (2) and cold action seals (6) packed in a two-layer construction, all arranged in cabinets that enable, mostly thanks to the said seals, prevention of flames, heat and smoke ingress through the gaps between any two adjacent cabinet modules.

### TECHNICAL FIELD

The present invention relates to an innovative system and method of design in compact archive cabinets used to store valuable inventory, pieces of art, and other materials, items and documents that need preservation in museum, library or office-like environments, that provides passive humidity and fire control inside.

### CURRENT STATE OF THE ART

Speaking for the present day, historical and recent documents, inventories and pieces of art of value receive more significance than ever, when it comes to their preservation. Therefore, the public interest in and demand has grown drastically immense for designs and methods especially developed for cabinets and archiving units where documents may safely be retained ad protected against fire.

In the current state of the art, not any particular system of cabinets can offer full fire protection right from the moment when a fire emergency starts, due to various discrepancies found in their design.

The compact archiving systems referred in the current state of the art are manufactured of metallic frames, having different numbers of drawer units moving on a floor-fixed track or rail platform, integrated to the body frames for bringing them together. For multiple cabinet units, a single access door is used to reduce the number of access aisles in between the rows of stacks as different from the conventional fixed shelf systems, whereby maximum archiving space is intended to be achieved by perfectly making use of the entire volume of the archiving location. By doing so, the daily-growing demand for gradually expandable archiving spaces is properly responded. However, in this case, the artworks have to be stored and maintained in a confined space inside the metallic structure in which the cabinets are manufactured. This eventually results in an embodiment, which fails short of protecting the artworks, because the materials used in construction stimulate mould and fungal growth.

What the cabinet systems mentioned in the current state of the art are designed to contain is merely valuable artwork composed of a diversely atypical range of organic and inorganic substances. The current cabinet systems therefore fall inefficient for protecting the said artwork against moisture build-up and fire. This fact, in turn, facilitates formation of moulds on surfaces of the artworks and inflicts irretrievable damage upon irreplaceable property.

The cabinet systems mentioned in the current state of the art are mostly located in subterranean levels of multi-storey buildings. And such locations are typically characterised with intense condensation. While the cabinet designs bring protection upon archival materials against dust and fire, which is why, they have been conceived in a closed structure, to function as safeguards. Indifferently metallic in construction, the said cabinets lay traces of increasing levels of moisture, when kept in closed position. Since this very fact means harm to the artworks themselves, they plainly fail to keep highly valued masterpieces safe and sound.

In another instance of the current state of the art, the archiving location is devised with precision air-conditioners, as a means of active protection. It goes without saying that each such system as prescribed will yield extra costs in terms of annual maintenance and repairs. What's more, the precision air-conditioners erected inside the location usurps the volume of available space dedicated to safekeeping of the archives. Another noteworthy drawback is that there is the risk of water leaking into the archival space, whenever a running air-conditioning system somehow gets damaged. This potential puts all the stored artworks in danger.

In the case presented, a system of compact cabinets that comprises multiple components of metallic construction containing fire-retardant frames inside is depicted, where the manufacture of each component, seems to have an error margin at relatively higher tolerance levels. The bigger a cabinet system gets in size, the greater the gaps/aperture becomes in between the units, disabling full closure of the units. In this case, perfect fitting of the various units and components with one another is prevented, which, in turn, takes away the last chance of achieving an orderly and compact appearance, let alone full registration of all stored items.

The cabinet systems mentioned in the current state of the art employ swelling seals at points of intersection of the units. These seals are a few millimetres thick. In order for them to be able to react with fire and swell to prohibit ingress of flames, attainment of a preset threshold by the ambient temperature is a requisite (i.e. 190° C. in the case of products of sealbifire brand). For this reason, any possibility of achieving a firm seal and leak-tightness is eliminated, no matter how perfectly the seals close the gaps by swelling and filling in. In such case, the flames and smoke penetrates into the cabinet, causing harm to the documents in storage.

In this example of cabinet systems from the current state of the art, the modules that collectively form up the system is manufactured and installed with a typical gap tolerance of 3 cm between one another at installation locations, by requirement and in pursuance of applicable safety standards. The intumescent seals are able to multiply their spatial coverage by 10 to 12 times in average. Under these circumstances, the maximum width that a 2 mm-thick intumescent sealing strip can effectively cover is 24 mm, or 2.4 cm. Since the intumescent seals employed by these systems fall insufficient to cover the inter-modular gaps, in combination with normal defects of the metallic structures used, instant rise in temperature and smoke leakages induced by an event of fire will eventually harm the documents being preserved inside the containers.

In another example of the current state of the art, the intumescent sealing strips between the cabinet modules are affixed unto metallic frames. The metallic frames employed do not conform to the safety standards. They only serve for concealing the inter-modular gaps from sight of the user and supporting the intumescent sealing strip. The metallic frames may impose harm to fingers or a hand upon squeezing by their closure.

In another state of the art, metallic sheets are not employed between fire-retardant panels and the artwork to be preserved. This causes formation of dust due to frames' being hit multiple times during emplacement of artwork inside containers or installation of racks and indirect damage to the artworks.

Another exemplary embodiment found in the current state of the art, when search is extended to cover local applications filed in relation to a similar cabinet design is the patent application filed with application number TR 2016/18588, with the title “A vehicle recognition system”. This application, in summary, relates to “(1) a mechanism of containment, archiving and storage (2) comprising at least one enclosure that can slide and demarcates the inner compartment (3) for inclusion of various types of products between a standstill configuration on a surface facing an access aperture leading to the inner compartment (3), and a surface-splitting configuration. At least one enclosure (2) includes at least one related frame cover (4), made of materials with known fire-proof properties, formed alongside its walls. According to the narratives of the invention, the mechanism provided (1) incorporates at least one sensor for detection of the correct configuration of at least one enclosure (2) based on positioning of the surface that it faces, which is controlled by driving system for auto-restoration of stop/standstill configuration and a special apparatus selectable between a variety of signalling systems for setting the default configuration of the enclosure (2).” As mentioned above, notion is made to an archival and storage cabinet system with fire-proof properties. Since this system employs intumescent sealing strips in place of sealing gaskets, which fail to provide full fire-proofing by nature and design, and given the mandatory defects inherent in its practical implementation, as well as the lack of moisture protection, it can hardly be the choice of preference for many industrial practices.

In conclusion, due to the odds and caveats having been prescribed and to the examples given above, in combination with extra cost burden imposed upon the customers and lack of adequacy felt with the existing solutions, an innovation has become of need in the compact cabinets forming the subject of our invention.

### SUMMARY OF THE INVENTION

The present invention relates to an innovative technique and system that effectively address all the aforementioned concerns, and, in addition to totally eliminating all the disadvantages, provides some additional advantages for compact cabinets.

The primary goal of this invention is to insure that documents stored in cabinet systems against risks of fire and fungal and moisture build-up due to heightened levels of condensation.

Another purpose of this invention is to strengthen fire-proof qualities within a cabinet module by creating a double barrier through the use of cold action seals that provide proofing as well as leaktightness, and are normally used for combining parts together.

A further purpose of this invention is to achieve and retain proofing at any instant and on a continuous basis by simply filling the entire gap in between the actual positions of any two modules through insertion of cold action sealing stripes manufactured to the size of 25×30 mm or 30×30 mm.

A further purpose of this invention is to procure for complete closure of the gaps in between consecutively running rows of cabinet modules and thereby, elimination of all possible threats to life and personal safety, by means of sealing cabinet walls safely making use of the spongy (elastic) construction of cold action sealing gaskets and eliminating the metallic frames holding intumescent seals in place.

Another purpose of this invention is to ensure protection of documents and inventory items stored in the system of cabinets against moisture, through performance of passive condensation and moisture checks after absorption of excess moisture.

A further purpose of this invention is to provide added protection for the documents stored in cabinets, by finishing cabinet walls with an overlay of fire and moisture resistant materials.

A further purpose of this invention is to achieve fire-proofing of the cabinet modules, through the use of dual functioning surfaces capable of absorbing excess moisture.

A further purpose of this invention is to prevent any odds from happening such as the extra cost burdens on the part of customers, unnecessary loss of space and equipment malfunctions putting artworks under serious threat, by deploying and implementing a passive protection for valuable artwork in archival compact cabinet systems.

Since various structural and characteristic features of, and all benefits that this invention has to offer are revealed to the slightest detail on the illustrative drawings, a brief description of which is provided below, in combination with cross-references made in the lexical context hereof to these drawings for convenience and ease of reference, it is highly recommended for the readers to consider both these drawings and the detailed explanations together, before making an overall assessment to draw a final judgment on patenting eligibility and genuineness of this invention.

### BRIEF DESCRIPTION OF DRAWINGS SUPPLIED AS AN AID FOR A BETTER UNDERSTANDING OF THE INVENTION

The so-called “innovation in compact cabinets”, which forms the subject of this application, is fully illustrated on the drawings attached, consisting of:

FIG. 1: A representative illustration of various parts of a single double-sided unit that embodies the “innovation in compact cabinets”, in exploded view.

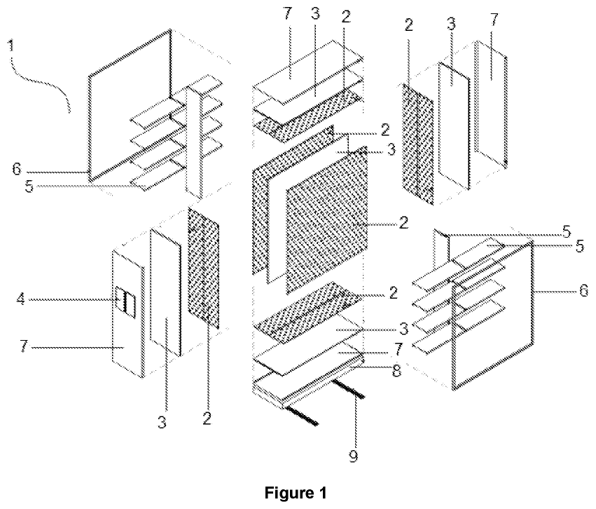

FIG. 2: A representative illustration of the frames and parts that collectively make up the “innovation in compact cabinets” which forms the subject of this application, as mounted inside a double and single-sided cabinet, in perspective view.

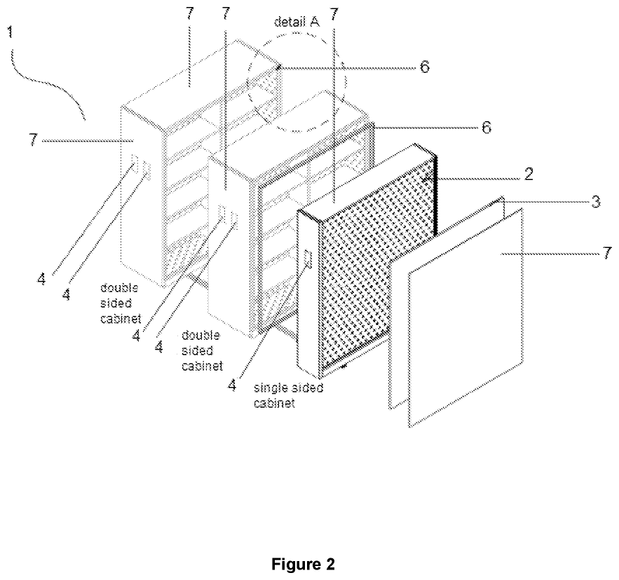

FIG. 3: A representative illustration of the frames and parts that collectively make up the “innovation in compact cabinets” which forms the subject of this application, as mounted inside a double and single-sided cabinet, in top view.

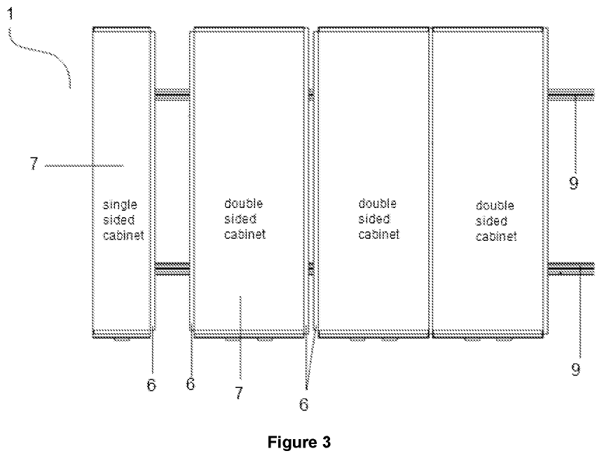

FIG. 4: A representative illustration of the frames and parts that collectively make up the “innovation in compact cabinets” which forms the subject of this application, as mounted inside a double and single-sided cabinet, in sectional view.

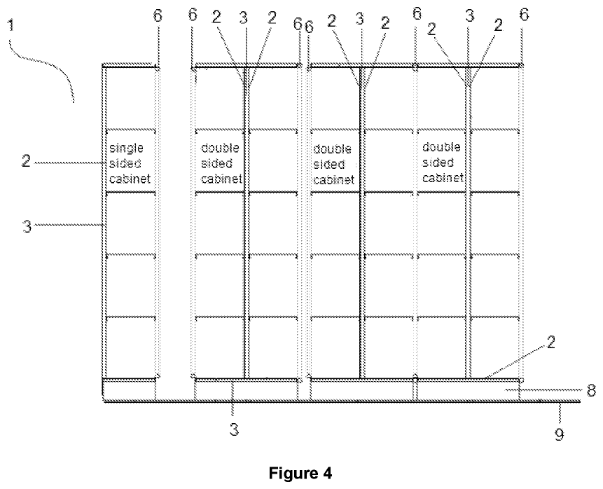

FIG. 5: A representative illustration of the point of intersection of various frames with cold action seals (6) from different insertion spots and positions, in detailed view.

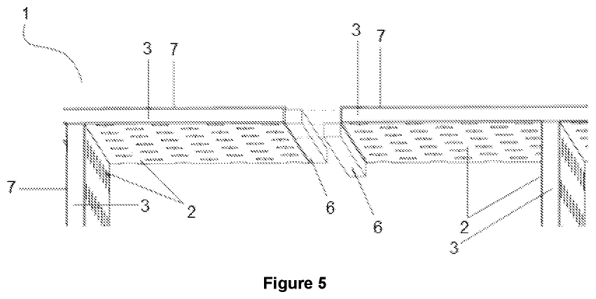

It should be noted that the drawings should not necessarily fit with actual scale of a fully functional system and unnecessary details might have been eluded/ignored to assure a proper insight to the invention in its presented embodiment. Apart from this, components that are, or, at least have functions identical with one another are marked with identical numbers to bring about unity between the textual and visual contents.

### EXPLANATION OF PART REFERENCES

1. An innovation in compact cabinets
2. Perforated metallic sheet
3. Insulating frame
4. Control panel
5. Inner accessory
6. Cold action seal
7. Outer cover
8. Bottom carriage
9. Motion rail

### DESCRIPTION OF THE INVENTION IN DETAIL

This section describes the preferred embodiments of the innovation in compact cabinets, in such a manner that guarantees a better insight to the concept, while avoiding infliction of any limiting, constraining effect upon the readers.

The innovation in compact cabinets that form the subject of the present invention (1) consists of an insulating frame firmly placed inside the closed walls of the cabinet (3), a perforated sheet of metal (2), an inner accessory in which books and documents are to be placed (5), a cold action seal that ensures a fair level of fastening between cabinet modules (6), an outer cover (7), a bottom carriage that encloses the movement mechanism (8) at the bottom section of the cabinet and on which various structural components of the cabinet are rested, and a motion rail to ensure easy handling, opening and closing of the cabinet (9).

The perforated metallic sheet (2) acts as a mantle that cloaks the roof, ground, back, interface, front and back insulating frames (3). This may be supplied and used in a quantity of five, at most. Its number tends to increase in proportion to an increase in the number of insulating frames (3) used. An interface insulation frame (3) generally used in double-sided modules, there are two of these units to successfully cover the entire frame (3) from both sides. Regarding the treatment of inner surfaces, there are two viable options: whether the entire surfaces are covered with perforated metallic sheets (2), or, only some surfaces are covered with the remainder left permanently confined. The sheet cover permits contact of frames with the air circulated inside the system of cabinets, while preventing any accidental rubbing of the artworks with the circumferential frame. The roof insulation frame (3) has identical size with the ground insulating frame (3) and front and back insulating frames (3). Its scaling may vary depending on the actual cabinet dimensions of choice.

The insulating frames (3) are employed on the roof, at the interfacing section and rear side, in front, on ground of the modules of the system of cabinets and at the dorsa of the cabinet's secluded walls. They can be supplied in a maximum quantity of five. It transforms into the interfacing insulation frame (3) in double-sided modules, or the dorsal insulating frame (3) in single-sided cabinets. The insulation materials applied on outer surfaces of the module walls offer fire protection thanks to their flame retardant and heat resistant properties. The frames will absorb any excess moisture on build up in the environment inside the modules, thanks to the inner walls left half open. Thereby, a steady protection is also brought to the balance of relative humidity. They serve a dual purpose, as they provide a satisfactory level of protection against fire and moisture. These can be scaled according to the dimensions of the cabinets. They are made of lightweight alkaline material known for good capillary suction and extremely high water absorption capacities.

The control panel (4) is supplied in a minimum quantity of one on the front boards of both single and double-sided modules. It is positioned in place by fixing onto the outer cover (7). It is the electronics module that receives data from the resident humidity sensors placed inside the cabinets and shows the levels of environmental moisture build-up on a real time basis. The humidity sensor that shall be placed inside the compartment formed between the two modules where the artworks are to be placed facilitates transmission of required parameters by communicating with the cabinet system software.

The inner accessories (5) are the parts in which documents, inventories, items and stuff that are desired or required to be preserved can be placed, to be stored inside the cabinet. Its shape and size may vary depending on the types and heights of placement objects. It is possible to render placements more orderly and stationary for the whole duration during which documents and inventories are to be stored by simply repositioning them horizontally or vertically. Its numbers can be increased or reduced, depending on cabinet size.

The cold action seal (6) covers the void between two adjacent modules, brought together within the cabinet system, in two layers nested in one another. The seals inserted to the perimeter of the outer covers (7) constitute a housing for each other. They have a rectangular shape by design, which is expected to surround the entire outer cover (7) with perfection by form and size. They prevent ingress of flames, heat and smoke. When nested in one another after being manufactured in standard sizes of 25×30 mm or 30×30 mm, the gap between any two modules is fully covered, to ensure momentary and continuous proofing. The seals (6) have been designed to tolerate drifts by at least 5 cm to at most 6 cm, as may form in the gap between two modules. They are made of calcium silicate based fire-resistant material in dense spongy form.

The outer cover (7), ensures that the outer section of the cabinets are covered. Thereby, either the electronic or mechanical components of the movement parts within the cabinet and the cabinet's structural elements are hidden from plain sight. The control panel (4) fitted on top of them handles the transfers of data from moisture measuring sensors located inside the modules by means of the integration software module connected to the panel (4) and thus ensures permanent control over the humidity conditions of the environment. Its size may vary depending on the actual cabinet dimensions of choice.

The bottom carriage is the part of the cabinet which encompasses the motion rail (9) which holds all structural elements of the cabinet together and hidden wheels. The movement of the cabinets is assured by means of hidden wheels found inside, which, in electronically operated modules having transmission shafts, are driven by a motor connected to this shaft. An auxiliary function of the bottom carriage (8) is that it also delays the damaging of documents and artworks found inside the inner accessory (5), by ensuring their positioning at a high level above the ground, for instance, in case of a flood.

The motion rail (9), is mounted directly on the ground of the archiving location, to ensure that all cabinet modules run in parallel to one another and on the same axis, are closed properly and the whole cabinet weight transferred onto the concrete ground. It may be supplied in varying length and quantities depending on the number and weights of cabinet modules. It is fixed on the ground perpendicular to the cabinet, as a measure implemented to ensure uninterrupted motion till the ending point of travel of the cabinet modules, which are supposed to move together.

The innovation in compact cabinets (1), which forms the subject of the present invention, consists of a range of cabinet modules, the size as well as structure and number of the inner accessories (5) of which, may vary depending on the type of artwork they are supposed to accommodate. These modules may be double-sided to allow artwork access from both lateral sides, or, single-sided, to allow artwork access from only one lateral side. Each cabinet module that move altogether as one constitutes a compact system. In order for insulating frames (3) to function properly, the cabinet system should be sealed air-tight, when the modules unite with one another. This is why, the first and last member of a cabinet system should preferably be single-sided modules. In closed position, the modules will constitute a mass, all walls of which are protected by the outer cover (7). Movement of cabinet modules is ensured by means of a transmission shaft and a motor assembly attached to this particular shaft in case of electronically operated versions and controlling wheels hidden inside the bottom carriage (8). The bottom carriage (8) helps the modules to slide and close on the motion rail (9) fitted onto the ground. In order for the cabinet system to be sealed entirely, the gaps between the cabinet modules should be filled. The cold action (6) seals made part of the invention are fitted on the outer covers (7) of two reciprocally positioned modules that surround the inner accessories (5) of the latter, so as to present a hollow rectangular shape and serve as a housing for the insertion of their counterparts (6) on the other module. When the system is closed in this manner, it forms a protective surface tightly sealed to not let any ingress of heat, smoke and flames, yet flexible enough to tolerate opening/gap by up to 6 cm widthwise. Inside the cabinets, on the other hand, a perforated metallic sheet (2) that covers the innermost surfaces of insulating frames (3) facilitates absorption of excess moisture and balancing of humidity. Regarding the treatment of inner surfaces, there are two viable options: whether the entire surfaces are covered with perforated metallic sheets (2), or, only some surfaces are covered with the remainder left permanently confined. The humidity sensor that shall be placed inside the compartment formed between the two modules where the artworks are to be placed facilitates transmission of required parameters to the control panel (4), by communicating with the cabinet system software. This is the operating philosophy of the innovation in compact cabinets (1).

1. A compact cabinet system, comprising:
a perforated metallic sheet that permits contact of frames with air circulated inside the compact cabinet system, while preventing any accidental rubbing of artworks,
insulating frames made from flame-retardant and fire-proofing materials and moisture absorption material that ensure absorption of excess moisture build up in the interior parts of modules having frames that are left half open,
a control panel, which is an electronics module that receives data from resident humidity sensors placed inside the cabinet and shows the levels of environmental moisture build-up on a real time basis, and
inner accessories, which are parts of the cabinet system in which documents, inventories, items and stored materials that are desired or required to be preserved can be placed, to be stored inside the cabinet, and
cold action seals that cover voids between two adjacent modules, brought together within the cabinet system, in two layers nested in one another,
an outer cover that conceals the electronic and mechanical parts of a motion assembly and structural components of cabinets,
a bottom carriage, which encompasses a motion rail that holds all structural elements of the cabinet together and hidden wheels, and
a motion rail mounted directly on the ground of the archiving location, to ensure that all cabinet modules run in parallel to one another and on the same axis, are closed properly and that the whole cabinet weight transferred onto the concrete ground.

2. The compact cabinet system according to claim 1, comprising up to five perforated metallic sheets to cover roof, ground, back, interface, front and rear insulating frames.

3. The compact cabinet system according to claim 2, comprising perforated metallic sheets found on an interfacing insulation frame with double sides.

4. The compact cabinet system according to claim 3, comprising perforated metallic sheets in sizes varying depending on cabinet dimensions.

5. The compact cabinet system according to claim 1, comprising insulation frames covering at least five surfaces that expand on secluded walls of the cabinets with locations on the roof, at the interface, back and front sides of the individual modules that collectively form up the cabinet system.

6. The compact cabinet system according to claim 5, comprising insulating frames made of fire-resistant and flame retardant insulating materials.

7. The compact cabinet system according to claim 6, comprising insulating frames that absorb excess moisture to retain relative humidity levels in balance.

8. The compact cabinet system according to claim 7, comprising insulating frames manufactured of lightweight alkaline material known for good capillary suction and extremely high water absorption capabilities.

9. The compact cabinet system according to claim 1, comprising at least one control panel that displays current humidity parameters inside each modular cabinet and monitors humidity and temperature values.

10. The compact cabinet system according to claim 1, comprising an inner accessory, the shape and size of which is adjustable according to the type and height of the pieces to be stored.

11. The compact cabinet system according to claim 1, comprising cold action seals (6) employed in appropriate sizes on the cabinet modules in sizes of 25×30 mm and 30×30 mm.

12. The compact cabinet system according to claim 11, comprising a cold action seal capable of tolerating up to a minimum drift of 5 cm that may potentially occur inside gaps between modules.

13. The compact cabinet system according to claim 12, comprising a cold action seal that overlays the entire perimeter of the outer cover, serving as a housing for connections between any two reciprocally situated modules.

14. The compact cabinet system according to claim 13, comprising a cold seal designed originally in rectangular shape, yet in such form and size as needed to embrace the entire circumferential length of the outer cover.

15. The compact cabinet system according to claim 14, comprising cold action seals made of calcium silicate based fire-resistant material in dense spongy form.

16. The compact cabinet system according to claim 1, comprising perforated an outer cover with size varying according to the cabinet dimensions.

17. The compact cabinet system according to claim 1, comprising a bottom carriage that enables the movement of the cabinets by hidden wheels found inside, which, in electronically operated modules having transmission shafts, are driven by a motor connected to the transmission shafts.

18. The compact cabinet system according to claim 1, comprising perforated metallic sheets, insulating frames and an outer cover that is suitable for use in double or single-sided design configurations, in order to ensure a perfect sealing of the cabinet system to block all possible entries of air, for insulating frames to function properly, in a setup with first and last members of the cabinet system are composed of single-sided modules, so as to permit access to contained artwork from either sides.
